(19) United States
(12) Patent Application Publication
(10) Pub. No.: US 2005/0031508 A1
(43) Pub. Date: Feb. 10, 2005

(54) Apparatus for manufacturing chlorine dioxide

(76) Inventor: Koji Abe, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/909,308

(22) Filed: Aug. 3, 2004

(30) Foreign Application Priority Data
Aug. 4, 2003 (JP) 2003-286144

(51) Int. Cl. B01F 1/00; C01B 11/02

(52) U.S. Cl. 422/230

(57) ABSTRACT

An apparatus for manufacturing chlorine dioxide comprises a reaction chamber which enables to generate chlorine dioxide by subjecting a chlorite solution to react with an acid, chlorite solution supplying means enabling to continuously supply the chlorite solution to the reaction chamber, acid supplying means enabling to continuously supply the acid to the reaction chamber, an aeration device enabling to continuously aerate air into a mixed solution of the chlorite solution and the acid supplied to the reaction chamber, a removal passage enabling to remove a chlorine dioxide gas in the reaction chamber, a drain pipe enabling to continuously drain away waste liquid which finishes reaction in the reaction chamber, and means optionally adjusting an amount of chlorite solution supplied by the chlorite solution supplying means, an amount of acid supplied by the acid supplying means and an amount of air aerated by said aeration device.

### BACKGROUND OF THE INVENTION

1. Field of the Invention

The present invention relates to an apparatus for manufacturing chlorine dioxide.

2. Description of the Background Art

Chlorine dioxide, which has strong oxidizability and sterilizing ability, is a substance with a melting point of −59° C., a boiling point of 11° C. and of a gaseous state at room temperature; has solubility of approximately 3000 ppm (mg/l) to water at an ambient temperature and pressure; has explosivility not less than 10% of gas concentration in the air; and is used for sterilization, disinfection, deodorization, bleaching and the like.

Conventional apparatuses for manufacturing chlorine dioxide produce chlorine dioxide solution by reacting raw chemicals, along with mixing them, under an ambient temperature and pressure as shown in Japanese Published Unexamined Patent Application No. H9-20502. However, since the chlorine dioxide in the chlorine dioxide solution is dissolved as a gas, those apparatuses employ methods of aerating the mixed solution of chlorite solution and acid in a container to obtain chlorine dioxide gas solely.

However, those conventional methods have a drawback in that the mixed solution of chlorite solution and acid in the container must be replaced by each batch operation.

Moreover, since the concentration of the mixed solution of chlorite solution and acid once fed in a container is decreased over time, those methods have other drawbacks which make the mixed solution unsuitable for uses for long periods; such drawbacks are that it is difficult to keep consistency of the concentration of generated chlorine dioxide gas, it is impossible to obtain the chlorine dioxide gas in the pre-determined concentration when using the mixed solution after being stored in a container for days, and so on.

The present invention has been undertaken considering the above described drawbacks, and is intended to enable to generate chlorine dioxide gas easily, safely and economically for a long period with an arbitrary constant concentration.

### SUMMARY OF THE INVENTION

The first characterized constitutions of the present invention are comprised of a reaction chamber enabling to generate chlorine dioxide by subjecting chlorite solution to react with acid; means for supplying chlorite solution enabling to continuously supply the chlorite solution to said reaction chamber; means for supplying acid enabling to continuously supply the acid to said reaction chamber; an aeration device enabling to continuously aerate air into a mixed solution of chlorite solution and acid supplied to said reaction chamber; a removal passage enabling to remove chlorine dioxide gas in said reaction chamber; a drainage passage enabling to continuously drain away waste liquid which finishes the reaction in said reaction chamber; and means optionally adjusting an amount of chlorite solution supplied by said chlorite solution supplying means, an amount of acid supplied by said acid supplying means and an amount of air aerated by said aeration device.

The chlorite solution and the acid are supplied with the arbitrary amounts, for example, by small amounts, continuously in the reaction chamber to generate the chlorine dioxide; along with the gas generation, air is aerated with an arbitrary amount of air into the mixed solution in the reaction chamber to optionally adjust the concentration of generated chlorine dioxide gas; the generated gas is continuously removed through the removal passage as well as the chlorine dioxide gas of a determined concentration being continuously generated for a long period; and the chlorine dioxide gas is generated easily, safely and economically for a long period with an arbitrary constant concentration.

The second characterized constitutions of the present invention are comprised of a passage enabling to blow air for dilution being set enroute of the above mentioned removal passage.

By means of blowing air for dilution into the chlorine dioxide gas in the removal passage, the chlorine dioxide gas removed from the reaction chamber is, for the purposes of being effectively used for disinfection, deodorization and bleaching, instantly diluted to a low concentration; moreover by means of blowing the diluted chlorine dioxide gas into ducts for air conditioning, the diluted gas can be utilized for prevention of airborne infection in large scale facilities and for other uses.

Furthermore, from the solution containing chlorine dioxide gas generated by the reaction, the chlorine dioxide gas which does not contain chlorides such as sodium chloride formed while the chlorite solution and the acid being reacted, is solely and instantly diluted to release the diluted chlorine dioxide gas which does not precipitate by-product chlorides on the objects to be treated, thereby being continuously utilized for various usages with an arbitrarily constant concentration for a long period.

The third characterized constitutions of the present invention are comprised of a support which supports chlorite solution and acid, and enables to generate chlorine dioxide by subjecting the supported chlorite solution to react with the supported acid; means for supplying chlorite solution enabling to continuously supply the chlorite solution to said support; means for supplying acid enabling to continuously supply the acid to said support; a blowing device enabling to release the generated chlorine dioxide as chlorine dioxide gas by continuously blowing air to said support; a removal passage enabling to remove said chlorine dioxide gas; a drainage passage enabling to continuously drain away waste liquid which finishes reaction on said support; and means optionally adjusting an amount of chlorite solution supplied by said chlorite solution supplying means, an amount of acid supplied by said acid supplying means and an amount of air blown by said blowing device.

The chlorite solution and the acid are supplied with the arbitrary amounts, for example, by small amounts, continuously in the support to generate chlorine dioxide; along with the chlorine dioxide gas generation, particularly without aeration, air is blown with an arbitrary amount of the air to the support to optionally adjust the concentration of released chlorine dioxide gas; the gas is continuously removed through the removal passage as well as the chlorine dioxide gas of a determined concentration being continuously generated for a long period; and the chlorine dioxide gas is generated easily, safely and economically for a long period with an arbitrary constant concentration.

### DESCRIPTION OF THE DRAWINGS

FIG. 1 is a schematic view of the apparatus for manufacturing chlorine dioxide.

FIG. 2 is a schematic view of the apparatus for manufacturing chlorine dioxide in Embodiment 2.

FIG. 3 is a schematic view of the apparatus for manufacturing chlorine dioxide in Embodiment 3.

### DESCRRIPTION OF THE PREFERRED EMBODIMENTS

The embodiments of the present invention will be described based on the drawings as follows.

### Embodiment 1

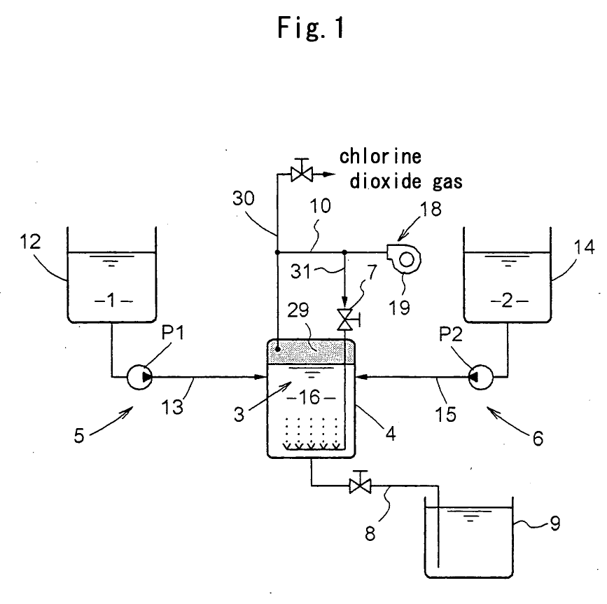

FIG. 1 illustrates the apparatus for manufacturing chlorine dioxide of the present invention. The apparatus includes a sealed reaction vessel 4 providing internally a reaction chamber 3 which enables to generate chlorine dioxide by subjecting an aqueous solution of sodium chlorite (an example of chlorite solution) 1 to react with a hydrochloric acid (an example of acid) 2; aqueous sodium chlorite solution supplying means 5 enabling to continuously supply the aqueous sodium chlorite solution 1 to the reaction chamber 3; hydrochloric acid supplying means 6 enabling to continuously supply the hydrochloric acid 2 to the reaction chamber 3; an aeration device 18 enabling to continuously aerate air into a mixed solution 16 of the aqueous sodium chlorite solution 1 and the hydrochloric acid 2 supplied to the reaction chamber 3; an air control valve 7 for optionally adjusting an amount of air aerated by the aeration device 18; a removal passage 30 enabling to remove a chlorine dioxide gas 29 in the reaction chamber 3; and a drain pipe 8 enabling to continuously drain away waste liquid which finishes reaction in the reaction chamber 3.

The above mentioned aqueous sodium chlorite solution supplying means 5 is constituted by connecting a first pump P1 to a first supply pipe 13 which connects a first chemical liquid tank 12 storing the aqueous sodium chlorite solution 1 to the reaction chamber 3, for the purpose of supplying the aqueous sodium chlorite solution 1 to the reaction chamber 3 by driving the first pump P1; and optionally adjusts the supplied volume of the aqueous sodium chlorite solution 1 by adjusting the rotation speed of the first pump P1 and the like.

The above mentioned hydrochloric acid supplying means 6 is constituted by connecting a second pump P2 to a second supply pipe 15 which connects a second chemical liquid tank 14 storing the hydrochloric acid 2 to the reaction chamber 3, for the purpose of supplying the hydrochloric acid 2 to the reaction chamber 3 by driving the second pump P2; and optionally adjusts the supplied volume of the hydrochloric acid 2 by adjusting the rotation speed of the second pump P2 and the like.

Moreover, the waste liquid after the reaction is finished, in which the concentration of the dissolved chlorine dioxide gas is quite low as a result of aerating the mixed solution of the aqueous sodium chlorite solution 1 and the hydrochloric acid 2 in the reaction chamber 3, is prepared to be stored in a waste liquid storage tank 9 through a drain pipe 8.

The above mentioned aeration device 18 is constituted by connecting an air supply pipe 31 equipped with the air control valve 7 to a blower 19; by inserting air outlets of the air supply pipe 31 in the mixed solution 16; and by enabling to aerate air from a blower 19 into the mixed solution 16 after adjusting the aeration volume with the air control valve 7 to remove the chlorine dioxide gas 29 volatilized from the aqueous chlorine dioxide solution through the chlorine dioxide gas removal passage 30.

Furthermore, by means of connecting enroute the air supply pipe 31 and enroute removal passage 30 with a bypass pipe 10, the air from the blower 19 is enabled to be blown as a dilution air into the enroute removal passage 30 for the purpose of instantly diluting the chlorine dioxide gas removed from the reaction chamber 3 to supply the diluted gas for usage such as sterilization, disinfection, deodorization, bleaching to the desired application fields.

### Embodiment 2

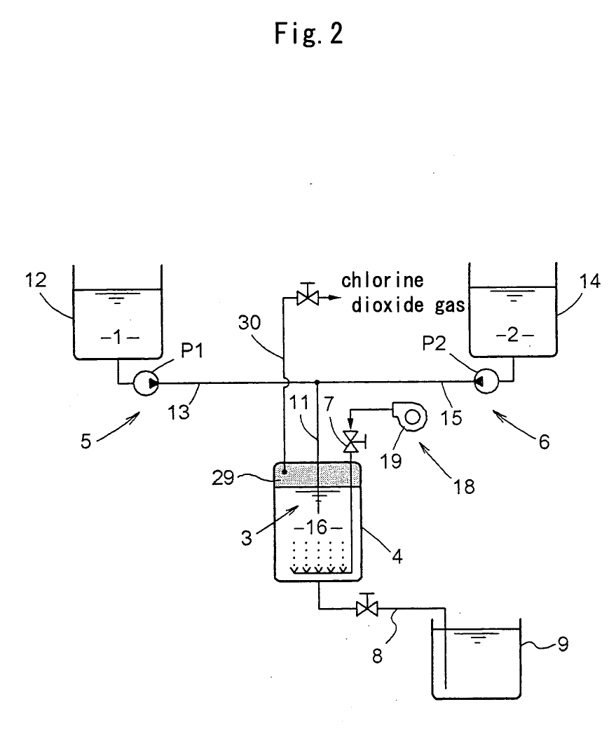

FIG. 2 illustrates another embodiment of the apparatus for manufacturing chlorine dioxide of the present invention. By means of connecting the first supply pipe 13 of the aqueous sodium chlorite solution supplying means 5 and the second supply pipe 15 of the hydrochloric acid supplying means 6 to a third supply pipe 11, the apparatus is constituted to make the aqueous sodium chlorite solution 1 and the hydrochloric acid 2 merge and mix in the third supply pipe 11 for the purpose of supplying the mixed solution 16 into the reaction chamber 3.

Other constitutions are the same as that of Embodiment 1 except that the bypass pipe 10 connecting the enroute air supply pipe 31 and the enroute removal passage 30 is not provided.

### Embodiment 3

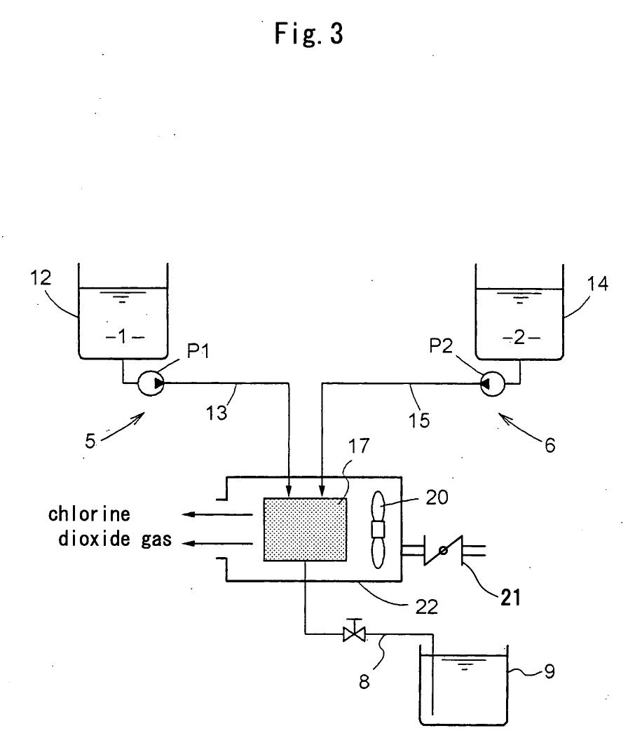

FIG. 3 illustrates another embodiment of the apparatus for manufacturing chlorine dioxide of the present invention. The apparatus is constituted with a support (absorber) 17 installed in a casing 22. The support 17 retains the mixed solution of a chlorite solution 1 and a hydrochloric acid 2 in a porous ceramic substrate, fluorocarbon fiber, stainless wire mesh or the like, and is able to generate chlorine dioxide by subjecting the chlorite solution 1 to react with the hydrochloric acid 2 in the retained mixed solution. The apparatus also includes chlorite solution supplying means 5 enabling to continuously supply the chlorite solution 1 to the support 17, hydrochloric acid supplying means 6 enabling to continuously supply the hydrochloric acid 2 to the support 17, a blowing device 20 enabling to release the generated chlorine dioxide as chlorine dioxide gas by continuously blowing air to the support 17, and a drain pipe 8 enabling to continuously drain away the waste liquid which finishes reaction on the support 17.

Furthermore, the apparatus is constituted so as to remove the released chlorine dioxide gas from the casing 22 by blowing air with the blowing device 20, to optionally adjust the supplied volume of the aqueous sodium chlorite solution 1 by adjusting the rotation speed of a first pump P1, to optionally adjust the supplied volume of the hydrochloric acid 2 by adjusting the rotation speed of a second pump P2, and to optionally adjust the blowing air volume from the blowing device 20 by adjusting an air control valve 21.

Other constitutions are the same as that of Embodiment 1.

### Other Embodiments

1. The apparatus for manufacturing chlorine dioxide of the present invention may use, as chlorite solution, an aqueous solution of alkali metal chlorite or alkaline-earth metal chlorite such as potassium chlorite and calcium chlorite and the like.

2. The apparatus for manufacturing chlorine dioxide of the present invention may use, as acid, mineral acids such as sulfuric acid, phosphoric acid and the like, an aqueous organic acid solution such as citric acid, tartaric acid and the like.

3. The apparatus for manufacturing chlorine dioxide of the present invention may be constituted to store the diluted chlorine dioxide gas in a storage tank, and, depending on need, to be able to supply to the desired application fields for use such as sterilization, disinfection, deodorization, bleaching.

4. The apparatus for manufacturing chlorine dioxide of the present invention may drain out the waste liquid after reaction is finished by its own gravity or by pumping out.

5. The apparatus for manufacturing chlorine dioxide of the present invention may be constituted to supply chlorite solution and acid respectively to the support.

6. The apparatus for manufacturing chlorine dioxide of the present invention may generate chlorine dioxide gas of a specifically constant concentration or chlorine dioxide gas in a specific tolerable concentration range.

1. An apparatus for manufacturing chlorine dioxide comprising: a reaction chamber enabling to generate chlorine dioxide by subjecting chlorite solution to react with acid; means for supplying chlorite solution enabling to continuously supply the chlorite solution to said reaction chamber; means for supplying acid enabling to continuously supply the acid to said reaction chamber; an aeration device enabling to continuously aerate air into a mixed solution of chlorite solution and acid supplied to said reaction chamber; a removal passage enabling to remove chlorine dioxide gas in said reaction chamber; a drainage passage enabling to continuously drain away waste liquid which finishes the reaction in said reaction chamber; and
means optionally adjusting an amount of chlorite solution supplied by said chlorite solution supplying means, an amount of acid supplied by said acid supplying means and an amount of air aerated by said aeration device.

2. The apparatus for manufacturing chlorine dioxide as set forth in claim 1, wherein a passage enabling to blow air for dilution is set enroute of said removal passage.

3. An apparatus for manufacturing chlorine dioxide comprising: a support which supports chlorite solution and acid, and enables to generate chlorine dioxide by subjecting the supported chlorite solution to react with the supported acid; means for supplying chlorite solution enabling to continuously supply the chlorite solution to said support; means for supplying acid enabling to continuously supply the acid to said support; a blowing device enabling to release the generated chlorine dioxide as chlorine dioxide gas by continuously blowing air to said support; a removal passage enabling to remove said chlorine dioxide gas; a drainage passage enabling to continuously drain away waste liquid which finishes reaction on said support;
and means optionally adjusting an amount of chlorite solution supplied by said chlorite solution supplying means, an amount of acid supplied by said acid supplying means and an amount of air blown by said blowing device.
